(19) United States
(12) Patent Application Publication
(10) Pub. No.: US 2002/0123879 A1
(43) Pub. Date: Sep. 5, 2002

(54) Translation system & method

(76) Inventor: Donald Spector, Union City, NJ (US)

Correspondence Address: LIEBERMAN & NOWAK LLP, 350 FIFTH AVE., SUITE 7412, NEW YORK, NY, 10118, US

(21) Appl. No.: 09/797,246

(22) Filed: Mar. 1, 2001

(51) Int. Cl. G06F 17/28

(52) U.S. Cl. 704/2

(57) ABSTRACT

A Web Browser wherein all of the displayed information on the Web Browser is in the language of preference of the user. The Web Browser is further configured to provide a transparent translation module, which dynamically interacts with the command structure of the Web Page, or default settings established by the user upon initial set-up, to provide, in essentially real-time, for user retrieval, and thus access to, virtually any information source on the web in his language preference, without the intermediate, and often confusing, instructions needed to translate a displayed Web Page from a language foreign to the user into the language preference of the user. In the preferred embodiments of the invention, a plurality of dynamic links are associated with a preconfigured Web Browser having a dominant theme, wherein the dynamic links are related to the dominant theme of the pre-configured server, thus, providing user access to related Web sites without searching and/or book-marking of web sites of common interest.

### BACKGROUND OF THE INVENTION

1. Field of the Invention

This invention relates to a system and method for automatic translation of information displayed on a Web Page into a language preference of the system user.

2. Description of the Prior Art

The Internet is a worldwide decentralized conglomeration of computer networks. The Internet has gained broad recognition as a viable medium for communicating and interacting across multiple networks. The World Wide Web (hereinafter the “Web”) was created in the early 1990's, and is comprised of servers (computers connected to the Internet) having hypertext documents or Web pages stored therewithin. These Web pages are accessible by client devices (hereinafter “clients”) using browser programs (hereinafter “browsers”) utilizing the Hypertext Transfer Protocol (HTTP) and the Transmission Control Protocol/Internet Protocol (TCP/IP). HTTP treats characters, images, tables, and the like as objects and provides various correlations between objects. Exemplary browsers include Netscape Navigator.RTM. (Netscape Communications Corporation, Mountain View, Calif.) and Internet Explorer.RTM. (Microsoft Corporation, Redmond, Wash.). Browsers typically provide a graphical user interface for retrieving and viewing Web pages hosted by HTTP servers.

A Web page, using a standard page description language known as HyperText Markup Language (HTML), typically displays text and graphics, and can play sound, animation, and video clips. HTML provides basic document formatting and allows a Web page developer to specify hypertext links (typically manifested as highlighted text) to other servers and files. When a user selects a particular hypertext link, the Web browser reads and interprets the address, called a URL (Uniform Resource Locator) associated with the link, connects the client with the Web server at that address, and makes a TCP/IP request for the Web page identified in the link. The server then sends the requested Web page to the client in HTML format which the browser interprets and displays to the user.

A URL is a standard addressing technique for identifying information resources on the Internet . The specifications for URLs are governed by RFC1738 which is one of the official Request for Comments documents prepared by the Internet Engineering Task Force (IETF). A URL gives the type of resource being accessed (e.g., Gopher, WAIS) and optionally the path of the file sought. For example: resource://host.domain/path/filename, wherein the resource can be “file”, “http”, “gopher”, “WMS”, “news”, or “telnet”. Through the Web, users can access the various Internet services, including Gopher, Telnet, and FTP.

The World Wide Web has also become an international medium for the exchange of commercial information and for electronic commerce. Literally millions of new Web pages have been developed in the past several years, throughout the world, as more and more individuals, businesses and organizations have discovered the power of Internet marketing. Many of these Web pages are written only in English. Non-English speaking users often have difficulty reading Web pages written in English, and thus may be precluded from a large amount of information available on the Internet.

Automatic translation software is available for translation of text on Web pages prepared in a foreign language, such as English, into text expressed in a user's native language such as Japanese, or vice versa.

Automatic translation software typically utilizes a database that contains information about various languages and a translation engine that refers to this database when performing automatic translation. Utilizing the database, data from a Web page is relayed by the automatic translation software using a Web browser's proxy function. A translated document is retransmitted to the Web browser and displayed on the user's screen. Exemplary automatic translation software of this type is “King of Internet Translation Ver 1.x,” sold by IBM Japan, Ltd.

Unfortunately, it can be difficult to automatically translate text in one language to text in another language so that the meaning of the original text is accurately reflected in the translation. This may often be a result of the ambiguity inherent in various languages. For example, ambiguity may arise from the use of words that have many meanings and that frequently appear in the text to be translated. Each time a word having many meanings appears in the text, the translation engine must select a meaning. Having little basis upon which to select a meaning, the word selection may be erroneous. Another source of ambiguity may arise from variations in grammar between different languages. English sentences, for example, have basic structural patterns of subjects, verbs and objects, such as “subject-verb-object.” When pronouns such as “that”, “which”, and “why” are omitted, understanding English sentence patterns and grammar may be difficult.

Multiple translating environments have been employed in order to ensure more accurate automatic translation. A “translating environment” typically includes a dictionary database and grammatical algorithms. Typical algorithms include setups for clauses, setups for auxiliary verb meanings, and various sentence stylistic designations. Portions of text typically must correlate with a translating environment. Similar words that are frequently used when referring to respective fields, such as the arts, sports, education and science, may have differing meanings and usages. Special translating environments, such as an Internet dictionary, an art dictionary, and a sport dictionary, for respective types of uses, are typically used within existing translating environments. Translating environments reduce unnecessary analysis during automatic translation and translation accuracy is often enhanced.

A typical method employed for selecting an appropriate translating environment is one where a user manually selects the appropriate translating environment in accordance with the contents of the original text. In this case, a user must understand the contents of the text before automatic translation is run. However, it may be difficult for a user to understand, at a glance, the contents of text written in a language other than his or her native language. Accordingly, the user may spend a lot of time trying to understand the text in order to select the proper translation environment.

Exemplary translating environments and methods are disclosed in Japanese Unexamined Patent Publications No. Hei 7-191999, Hei 6-332946, Hei 6-318229, Hei 6-60117 and Sho 61-173060. Disclosed therein is a translation system that automatically selects a translating environment. A translation system of this type may eliminate a number of the troublesome procedures required when a user selects a translating environment, and it may enhance work efficiency. However, most of the conventional techniques involve some analysis of the text before selecting a translating environment. Unfortunately, such analysis of the text of a Web page can be quite time-consuming and may complicate the translation.

The prior art is replete with computer based translation systems, including translation systems that are compatible with information retrieval on the Internet. The following is but a partial and representative description of a few of these offerings.

U.S. Pat. No. 4,706,212 (to Toma, assigned to Systran, S.A., issued Nov. 10, 1987) discloses a computerized translation method with universal application to all natural languages. With the Toma method, parameters are changed only when source or target languages are changed. The computerized method can be regarded as a self-contained system, having been developed to accept input tests in the source language, and look up individual (or sequences of) textwords in various dictionaries. On the basis of the dictionary information, sequences of operations are carried out which gradually generate the multiplicity of computer codes needed to express all of the syntactic and semantic functions of the words in the sentence. On the basis of all the codes and target meanings in the dictionary, plus synthesis codes of such meanings, translation is carried out automatically. Procedures which generate and easily update main dictionaries, idiom dictionaries, high frequency dictionaries and compound dictionaries are integral parts of the system.

The Toma patent is based upon a program for translating between source and target natural languages in accordance with a system wherein all the logical capabilities of the digital computer are first considered and a programming system is organized in a form which can be processed by the computer. To this end, new features were introduced in the language theory. A new part of speech concept breaks with the traditional parts of speech and organizes the functional classes in the language according to their most suitable form for processing by the computer. Codes are assigned to language units, to words, to expressions, and even to complete phrases in order to enable a program to correctly recognize the function of the words within the sentence. This is in sharp contrast to previous systems where codes were only assigned to individual words. The method involves a complete system which starts with the reading in of source language text, breaks the text down into individual words and looks up these words in various dictionaries. Codes are attached to the words which are indispensable for further processing and computer understanding of the source text. With the help of codes attached to individual words or expressions, the computer carries out a hierarchical analysis during which more and more codes are attached to each word. These codes express for the computer the syntax of the individual sentences and enable a subsequent program to find the meaning in the sentence as well as all those factors which influence the meaning within or without the particular sentence under analysis.

The concepts described in the Toma '212 have been implemented in a Web Browser format, and such Web Browser is commercially available under the trademark SYSTRANET®.

U.S. Pat. No. 6,119,078 (to Kobayakawa, et al, assigned to IBM, issued Sep. 12, 2000) discloses systems, methods, and computer program products for automatically translating a Web page from a first language to a second language when the Web page is downloaded from a server to a client in communication with the server Information user A requests that a Web page be downloaded from a server by transmitting a universal resource locator (URL) to the server. A URL is typically a character string identifying both the Web page and the server in which the Web page is located. The URL is interpreted and a database is searched for a URL or partial URL similar to at least a portion of the transmitted URL.

Each URL or partial URL in the database is associated with a translating environment. Accordingly, when a URL or partial URL is located in the database that is similar to the transmitted URL, the translating environment associated therewith is selected. The Web page transmitted to the client from the server is then translated from the first language to the second language using the selected translating environment. For example, a Web page in Japanese can be translated into English, or vice versa.

The translated Web page is displayed on a client display screen in the second language. The Web page may also be displayed in both the first language and the second language. If the second language is not the correct language, the user may select another translating environment from the database. This translating environment translates the Web page into a third language which may be displayed on the client display screen alone or in combination with either of the previous languages. In addition, a user may link a translating environment with a URL or partial URL and store this link within the database for future access.

Notwithstanding the advances in translation systems, and the efforts to automate such systems, there still exists a need to provide, at the outset, a Web Browser that is configurable or configured to a user's language of preference in order to eliminate, and thereby minimize, the instruction menu of the Web Browser needed to implement translation of information that is retrieved on the Internet with such a Web Browser. Clearly, neither the commercially available SYSTRANET® (available from Systran, S.A.) or WinDi® (available from Language Dynamic Corp.) Web Browsers eliminate this instruction menu, in a dedicated language, for effecting a translation of the retrieved information.

Similarly, the system described in the Kobayakawa, et al., '078 patent is anything but automatic. More specifically, the instruction menu of the Web Browser presumes that the user is fluent in the language of the instruction menu, or at least sufficiently fluent to formulate a search request. Where the requested materials are in a language different from the language of the instruction menu of the Web Browser, the system described in the Kobayakawa, et al., '078 patent selects a translation environment, based upon the language of the instruction menu, that is compatible with retrieved information and, thereafter, the information retrieved automatically is translated into the same language as the language of the instruction menu of the Web Browser. The translation routine of the Kobayakawa, et al., '078 patented system does not, however, permit the user to select or pre-set the instruction menu of the Web Browser to a language preference of the user, or to change the language preference of the instruction menu from one language to another. This latter capability is needed in pluralistic communities (schools, universities, government offices, etc.) that share a common Internet browser, or within cultural settings where such pluralism is fostered, in order to effectively utilize the instruction menu. Accordingly, the principle obstacle to the universal access to the Internet has not been effectively overcome, namely, the dedicated/pre-set language of the instruction menu that is resident in presently available Web Browsers.

### OBJECTS OF THE INVENTION

It is the object of this invention to remedy the above as well as related deficiencies in the prior art.

More specifically, it is the principle object of this invention to provide a simplified system and method for translation of information on the World Wide Web, that is geared to both an individual's preference/interests and displayed in his native language, or language preference.

It is another object of this invention to provide a simplified system and method for translation of information on the World Wide Web, that provides for real-time access and translation of Web Page information without laborious interpretation and manipulation of the displayed information in a language foreign to the user.

It is yet another object of this invention to provide a simplified system and method in the form of a “vanity browser” that is sponsored or associated with a group or personality and which provides a Web Page in a format geared to both an individual's preference/interests and displayed in his native language or language of preference.

It is still yet another object of this invention to provide a simplified system and method in the form of a “vanity browser” that is sponsored or associated with a group or personality and which provides for real-time access and translation of Web Page information without laborious interpretation and manipulation of the displayed information in a language foreign to the user.

Additional objects of this invention include provision of vanity browsers, featuring personalities or cartoon/animation characters, having the foregoing translation capabilities.

### SUMMARY OF THE INVENTION

The above and related objects are achieved by providing a Web Browser wherein all of the displayed information on the Web Browser is in the language of preference of the user. The Web Browser is further configured to provide a transparent translation module, which dynamically interacts with the command structure of the Web Page, or default settings established by the user upon initial set-up, to provide, in essentially real-time, for user retrieval, and thus access to, virtually any information source on the web in his language preference, without the intermediate, and often confusing, instructions needed to translate a displayed Web Page from a language foreign to the user into the language preference of the user.

This system performs this function by incorporation of a transparent translation module within the command structure of the Web Page, which is either preformatted in a language preference, or can be configured to default to a language preference when accessed. The transparent translation module can be adapted to web browsers by provision of a dynamic link to a commercially available translation engine such as are used in one or more commercially available web translation services (SYSTRANET®, available from Systran S.A., [city, state], WinDi Browser®, available from Language Dynamics Corp., San Diego, Calif.). As above noted and once again emphasized, the link to the transparent translation module can be through either the command structure of the Web Page, or through the default settings for language preference selected by the user. In either case, the user would simply use the Web Browser in the same manner as he would any other information in his language of preference. The system and method of this invention would be otherwise comparable in every other respect to standard Web Page architecture, and thus have a universal application in the international Internet environment.

In the preferred embodiments of this invention, the Internet Browser is pre-configured so as to have a dominant social, secular or religious theme and a plurality of dynamic links to servers/web sites accessible by said Internet Browser, so as to provide, user access to related servers/web sites without the need for additional searching and/or book-marking of related web sites that are similar and/or complimentary to the dominant theme of the pre-configured Internet Browser.

### BRIEF DESCRIPTION OF THE DRAWINGS

FIG. 1 is a typical Web Page translation system available from Language Dynamics, Corp., specifically, a WinDi Web Browser incorporating a command driven translation module.

FIG. 2 is a block diagram of the Web Browser incorporating the transparent translation system of this invention.

### DETAILED DESCRIPTION OF THE INVENTION INCLUDING PREFERRED EMBODIMENTS

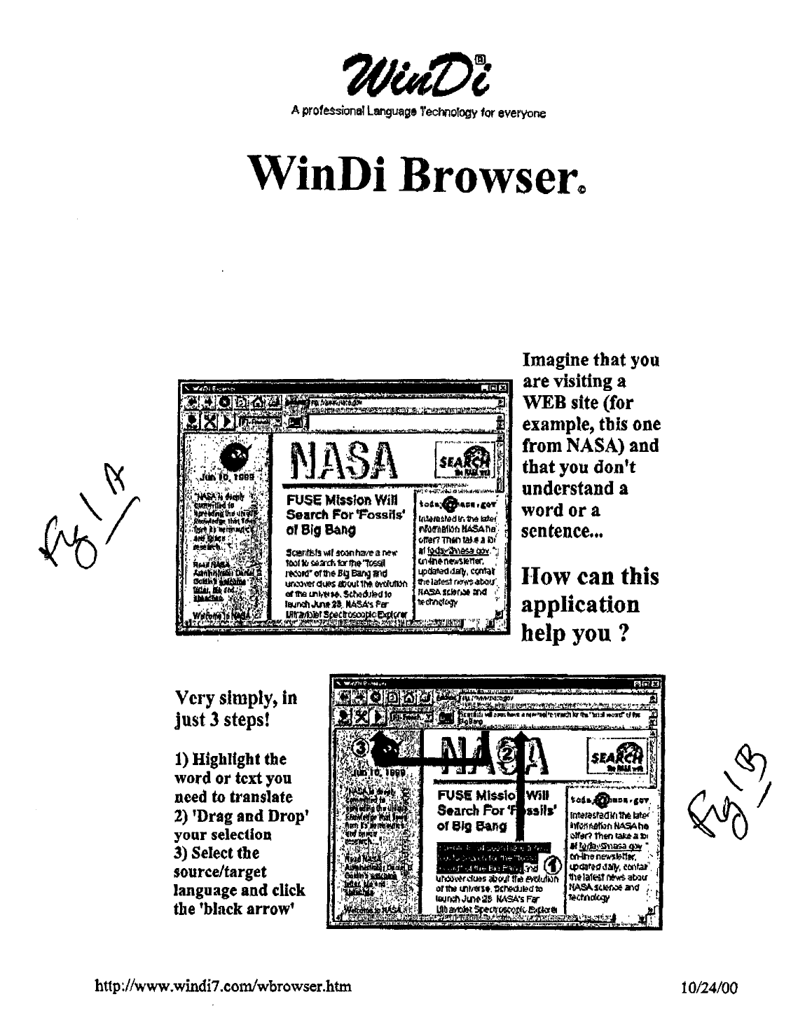

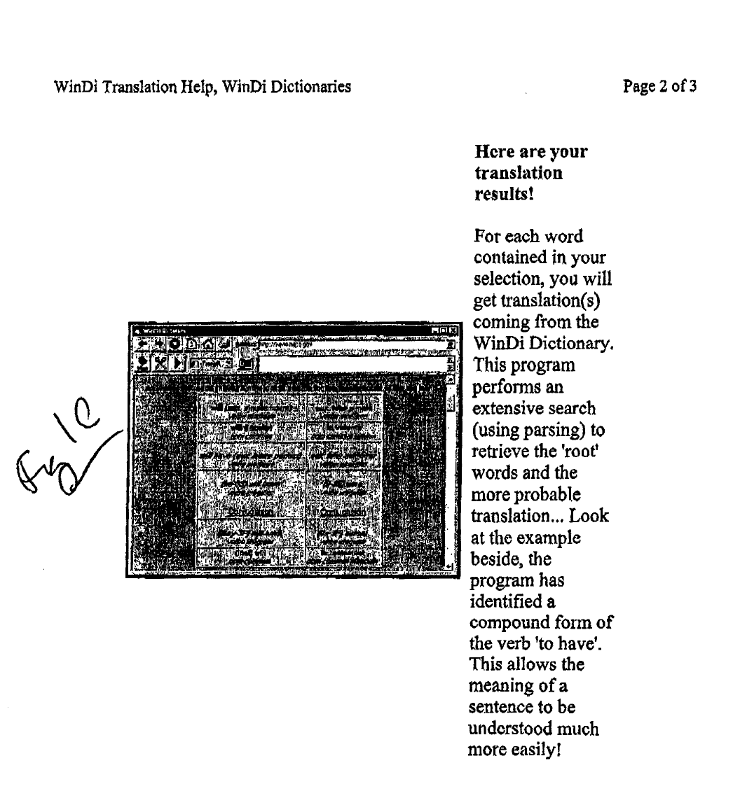

FIG. 1 is illustrative of the command structure of a commercially available Web Browser incorporating a command driven translation module. In brief, the Web Browser illustrated in FIG. 1 is in the English language. This Web Browser presumably is also available, or could be created in an language other than English. In either event, the command driven structure of this Web Browser is dedicated to a single language (hereinafter also “Instruction Language”), which is assumed to be other than the language of preference of the user. Accordingly, as illustrated in FIG. 1A, the user would have to search and retrieve information in the Instruction Language and attempt to interpret the results in a language other than his native language or language of preference. As illustrated in FIG. 1B, where he encounters information that is incomprehensible to him, or for which he requires a precise translation in his language of preference, he would Highlight the passage to be translated, Drag & Drop the Highlighted passage into a translation Box or Window, and activate the translation module. Upon completion of the translation, the user would thereafter Paste the translated passage back into the text of the article in the web page, as illustrated in FIG. 1C. Notwithstanding the purported effectiveness/accuracy of the resulting translation, the Instruction Language is relatively cumbersome, and is based upon the assumption that the user has sufficient familiarity with the Instruction Language to perform the multiple steps in the translation process. Obviously, this system is of marginal utility to a user that does not have sufficient mastery of the Instruction Language to follow the web page instructions, and probably would be beyond the capability of young children.

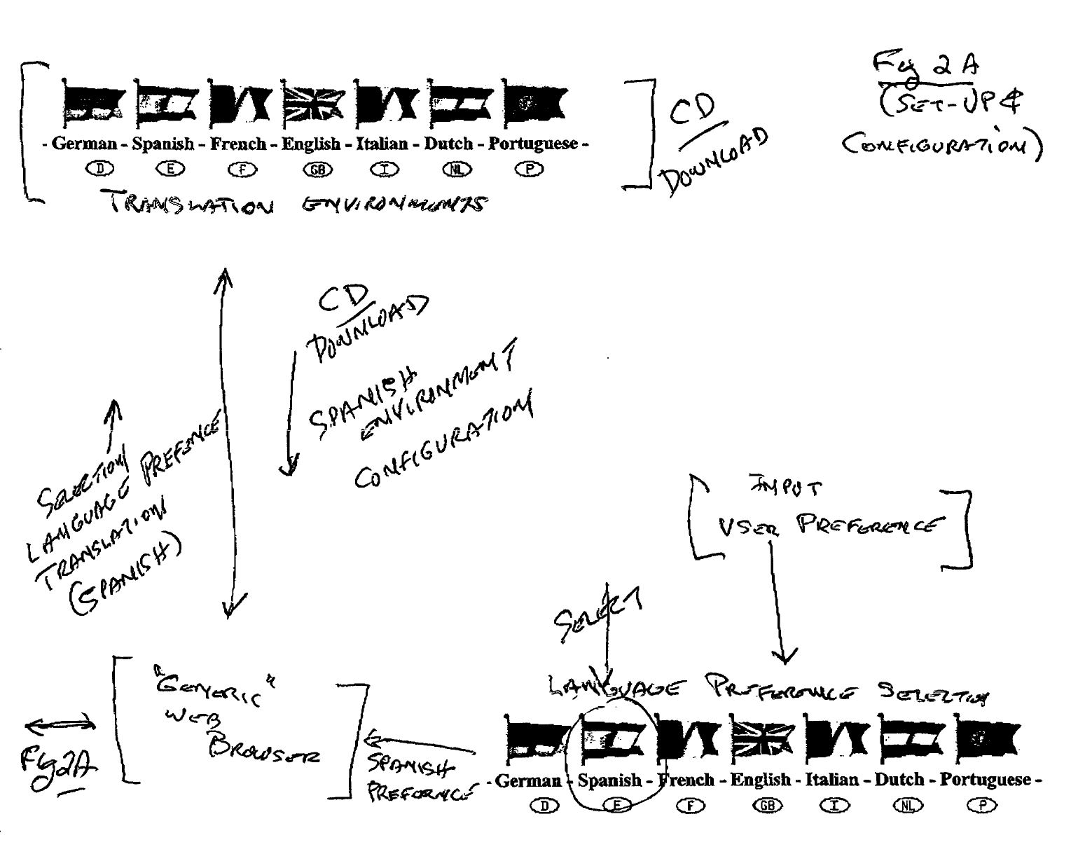

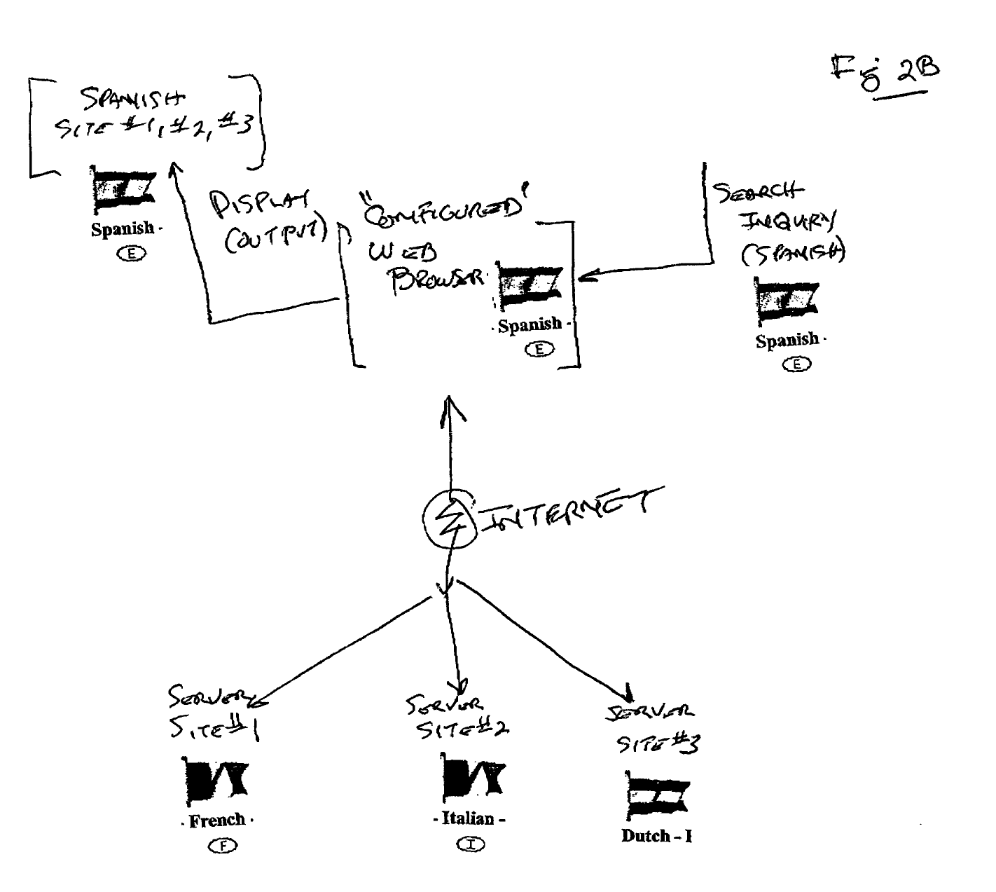

By way of contrast, FIG. 2 illustrates a system and method that eliminates the use of an arbitrary Instruction Language, by either coming “preconfigured” in the language of preference of the user (as illustrated in FIG. 2B); or, at the time of installation and set-up, can be configured, as illustrated in FIG. 2A, to default to the language of preference of the user. More specifically, at the time of installation, the user would simply insert a CD into his computer and start-up/install the software selection. He would, thereafter, choose this language of preference by selection of a graphic symbol, as illustrated in FIG. 2A, such as the country's national flag (e.g. Italian Flag Hot Button for selection of Italian as the default language of preference, French Flag Hot Button for selection of French as the default language of preference, etc.). The set-up could also include additional refinements where dialects or cultural idioms could effect the accuracy of the translation. More specifically, with regard to the Spanish language, the set-up could further include user designation of an Argentinean or a Venezuelan dialect, for example, in preference to a Mexican dialect, to insure that the proper language idioms would be recognized by the translation program. Once the user has made his selection, as illustrated in FIG. 2A, the appropriate translation module would be activated, or alternatively, downloaded to the user's computer, to complete the Web Browser configuration. Thus, the translation module would function much in the same way as “Plug In”, and thereby provide dynamic and real-time access to virtually any information on the Internet in the language of preference to the user.

The advantages of this system and method include not only translation of textual materials, but also legends and other information contained on graphic (maps, aeronautical maps, marine charts, and the like).

What is claimed is:

1. In an automatic translation system for use in combination with an Internet Browser having translation capabilities, which includes a social, secular or religious theme wherein the improvement comprises:
A. Providing a Internet Browser having a dominant theme that is configurable, or has been pre-configured, to display all information retrieval instructions in a language preference of a user, wherein essentially all search related functions are displayed in said language preference of said user;
B. A translation module associated with said Internet Browser, wherein said module is pre-selected for translation of information retrieved by said configured Internet Browser into said language preference of said configured Internet Browser; and
C. A plurality of dynamic links to related servers/web sites associated with said Internet Browser wherein said servers/web sites have a social, secular or religious theme, so as to provide user access to related servers/web sites without searching and/or book-marking of related servers/web sites of common interest.

2. The improved system of claim 1, wherein said language preference of said Web Browser is selected from the group consisting of English, Spanish, French, Italian, Greek, Portuguese, Arabic, Chinese, Japanese, and combinations thereof.

3. The improved system of claim 1, wherein the Web Browser includes a command set of user preferences based upon cultural interests.

4. The improved system of claim 1, wherein the Web Browser includes a command set of user preferences based upon religious affiliation.

5. The improved system of claim 1, wherein the Web Browser includes a command set of user preferences based upon social interests.
